(19) United States
(12) Patent Application Publication
(10) Pub. No.: US 2014/0058899 A1
(43) Pub. Date: Feb. 27, 2014

(54) INTERACTIVE RETAIL SHOPPING ENVIRONMENT AND INTERFACES EMPLOYED THEREIN

(71) Applicant: Mechtronics Corporation, Beacon, NY (US)

(72) Inventors: Richard J. Fellinger, Franklin Lakes, NJ (US); Keith Arndt, New York, NY (US); Richard J. Fellinger, JR., Austin, TX (US)

(73) Assignee: Mechtronics Corporation, Beacon, NY (US)

(21) Appl. No.: 13/974,880

(22) Filed: Aug. 23, 2013

Related U.S. Application Data
(60) Provisional application No. 61/743,003, filed on Aug. 23, 2012.
(60) Provisional application No. 61/715,052, filed on Oct. 17, 2012.

(51) Int. Cl. G06Q 30/06

(52) U.S. Cl. CPC G06Q 30/0643; G06Q 30/0623
USPC 705/26.62; 705/26.61

(57) ABSTRACT

An interactive retail shopping system includes one or more computing devices and a date store operatively coupled to the computing devices. Each of the computing devices includes a processor, memory operatively coupled to the processor and a display device operatively coupled to the processor for exhibiting data and information thereon. The data store includes data and information defining an inventory of merchandise. Each of the processors execute computer implemented instructions that allow consumers to locate, to review and to select merchandise from within the inventory of merchandise, and that allow a retailer to pick and to present the selected merchandise and alternative merchandise to the consumers for purchase within a retail shopping environment.

### CROSS-REFERENCE TO RELATED APPLICATIONS

This patent application claims priority benefit under 35 U.S.C. §119(e) of copending, U.S. Provisional Patent Applications, Ser. Nos. 61/743,003, filed Aug. 23, 2012, and 61/715,052, filed Oct. 17, 2012, the disclosures of these U.S. patent applications are incorporated by reference herein in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### BACKGROUND OF THE INVENTION

1. Field of the Invention

This invention relates to merchandise and/or product display systems and, in particular, to systems and methods providing interactive customer and retailer interfaces to digitalize aspects of a retail shopping environment, to improve the efficiency at which consumers locate and select merchandise, and at which retailers pick and supply the selected merchandise and/or alternative merchandise for purchase to the consumers.

2. Description of Related Art

In a retail shopping environment, consumers wish to quickly locate and select a product or service (hereinafter collectively referred to as “merchandise”) that they desire from among a wide variety of merchandise displayed or promoted on a retail floor of the retail establishment. Often, merchandise selection includes a review of information or features about the merchandise and for some merchandise like, for example, medications, limitations or warnings in use of the medication and interaction when using more than one different medication. As consumers may be interested in or concerned about a multitude and variety of information, features, limitations, warnings and the like, there often is a need to present a relatively large amount of information to prospective consumers. Providing a large amount of information in a retail environment can be difficult as retailers wish to maximum the revenue generated from each square foot of floor space in the retail environment. Traditionally, effectively ways of maximizing revenue is to increase the quantity and variety of merchandise displayed or promoted within the floor space. A need to dedicate areas for providing information rather than merchandise to prospective consumers appears to run contrary to most efforts by retailers to maximize revenues.

Accordingly, the inventors have discovered that conventional product display systems do not adequately exhibit information, features, limitations, warnings and the like, to prospective consumers. As such, the inventors have found that a need existing for providing interactive customer and retailer interfaces to digitalize aspects of the retail shopping environment, to improve the efficiency at which consumers locate and select merchandise, and at which retailers pick and supply the selected merchandise and/or alternative merchandise to the consumers for purchase.

Based on the foregoing, it is the general object of this invention to provide a product display system that improves upon, or overcomes the problems and drawbacks of, prior art product display systems.

### SUMMARY OF THE INVENTION

The present invention resides in one aspect in an interactive retail shopping system. The system comprises one or more computing devices each including a processor, memory operatively coupled to the processor and a display device operatively coupled to the processor for exhibiting data and information thereon. The system also includes a data store coupled to the one or more computing devices. The data store includes data and information defining an inventory of merchandise. The processor executes computer implemented instructions such that the processor allows consumers to locate, to review and to select merchandise from within the inventory of merchandise. The processor also executes computer implemented instructions such that the processor allows a retailer to pick and to present the selected merchandise, alternative merchandise and/or related merchandise to the consumers for purchase within a retail shopping environment.

In a particular embodiment, the data and information exhibited on the display device includes merchandising, promotional and purchasing data and/or information including pricing, product information including dosage, delivery form such as tablet and capsule forms, product's commercial name, UPC/SKU code, size, quantity, product warnings, and drug interaction cautionary notes.

In one aspect of the invention, the computing devices further include an electronic communication apparatus such that the computing devices communicate over a network with a server computing device. The server is configured to execute the retailer's existing inventory control system such that actions taken with the at least one computing device trigger a recommendation, evaluation and/or action within the retailer's existing inventory control system. In one embodiment, the action taken within the retailer's existing inventory control system in response to the trigger by the computing device includes reordering actions as the retailer's inventory of merchandise is reduced to a predetermined level.

According to another aspect, the invention provides a customer interface operable by the processor and including electronic tools operable to assist in the location, review and selection of merchandise from within the inventory of merchandise. In one embodiment, the electronic tools include an enlargement tool operable to provide an enlarged presentation of one or more characteristics of the merchandise. In another embodiment, the electronic tools include a product selection guide operable to provide customizable, searchable access to the merchandise by a search refinement tool that permits entry of search criteria, the search criteria defining a method for selectively filtering the merchandise within the inventory of merchandise.

In another aspect, the invention provides a retailer interface operable by the processor and including inventory control information related to selected items of merchandise from within the inventory of merchandise. In one embodiment, the retailer interface exhibits an order view and an inventory view of the selected items of merchandise. The inventory view of the retailer interface highlights at least one of one or more alternative merchandise that meet the consumer's selection and one or more of related and complimentary merchandise to the consumer's selection.

### BRIEF DESCRIPTION OF THE DRAWINGS

The features and advantages of the present invention will be better understood when the Detailed Description of Preferred Embodiments given below is considered in conjunction with the figures provided, wherein:

FIG. 1 is a simplified block diagram of an interactive retail shopping environment according to one embodiment of the present invention;

FIG. 2 is a simplified schematic diagram of a computing device employed within the interactive retail shopping environment of FIG. 1, according to one embodiment of the present invention;

FIG. 3 is a simplified schematic diagram of a Consumer Interface according to a particular aspect of the invention;

FIGS. 4 to 20 illustrate graphical user interfaces depicting portions of the Consumer Interface of FIG. 3;

FIG. 21 illustrates a graphical user interface depicting portions of a Consumer Interface according to a particular embodiment of the present invention; and

FIGS. 22 and 23 illustrate graphical user interfaces depicting portions of a Retailer Interface according to a particular aspect of the invention.

In these figures like structures are assigned like reference numerals, but may not be referenced in the description of all figures.

### DETAILED DESCRIPTION OF PREFERRED EMBODIMENTS OF THE INVENTION

In one aspect of the present invention, systems and methods facilitate merchandise selection and purchase in a retail shopping environment by providing interactive customer and retailer interfaces to digitalize aspects of the shopping experience to improve the efficiency at which consumers locate and select merchandise, and retailers pick and provide the selected merchandise and/or alternative merchandise to the consumers for purchase. Simply stated, by digitizing and providing electronic access to merchandising, advertising, promotional and other purchasing data and/or information such as pricing, product information including, e.g., dosage, delivery form (tablet, capsule, and the like), product's commercial name, UPC/SKU code, size, quantity, product warnings, drug interaction cautionary notes etc., process improvements are seen by both consumers and retailers. For example, from a consumer's standpoint, a customized search of information in the retail environment more readily leads to the identification of items of interest to them within a vast array of options available within the inventory of most retailers. From a retailer's standpoint, a wider variety of merchandise may be offered in otherwise limited and valuable “shelf space” and, in some embodiments, alternative and/or related merchandise may be identified such that a recommendation may be made to consumers at the point of purchase. In one embodiment an electronic presentation of inventory eliminates some perceived problems with conventional methods of having to provide access to physical inventory of merchandise or merchandise samples from a vast variety of merchandise options which it may wish to offer to consumers. Security concerns may also be addressed as the electronic inventory, unlike physical inventory, is not available for damage from customer handling or other loss such as from theft.

It should be appreciated that while the following description refers to a retail shopping environment and/or to merchandise available within a typical pharmacy, this description should not be limiting as it is within the scope of the present invention to be used in connection with any type or category of merchandise and within any sales environment not just retail sales environments.

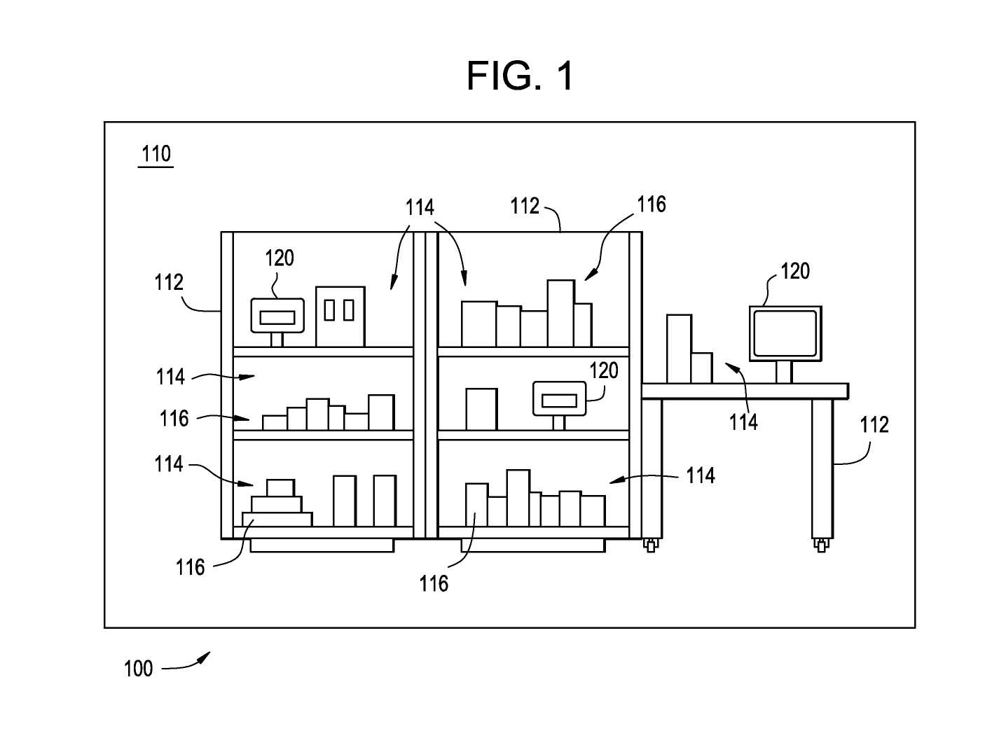

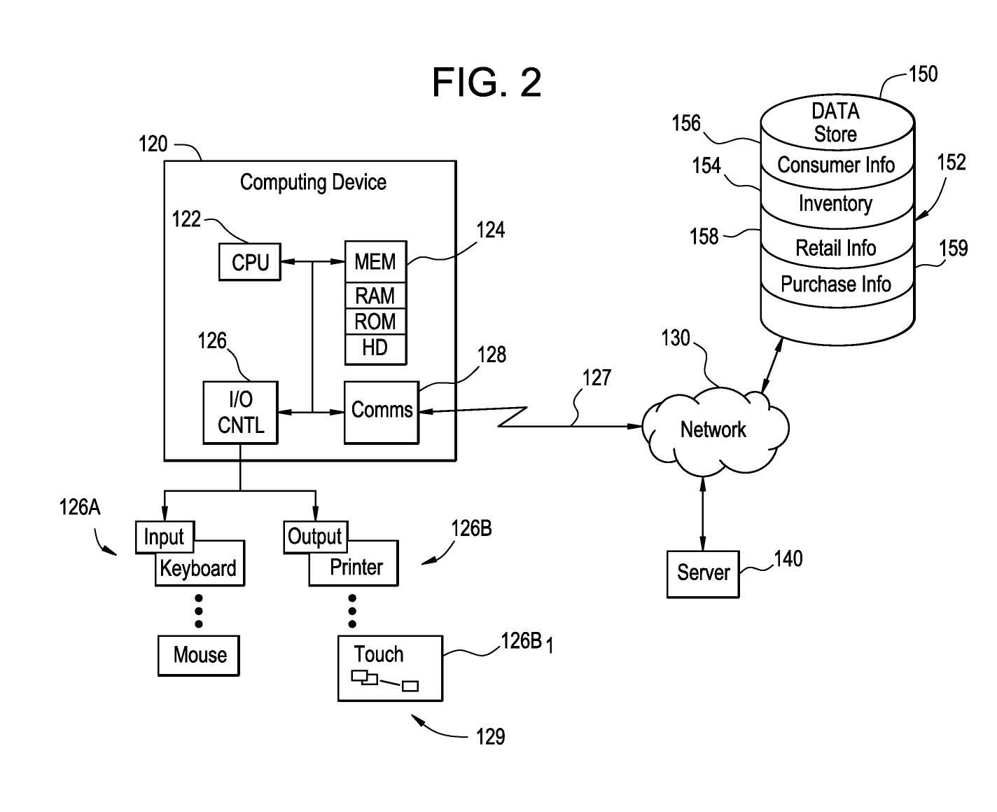

In one embodiment, illustrated in FIG. 1, a digital shopping system 100 includes one or more computing devices 120 disposed in one or more locations within an interactive retail shopping environment 110. It should be appreciated that the retail shopping environment 110 may include merchandise display systems having upright support structures, e.g., posts, walls, shelves, counters, tables, and the like, shown generally at 112, that provide display and/or work surfaces, shown generally at 114, for exhibiting merchandise 116 to prospective consumers. As shown in FIG. 2, the one or more computing devices 120 may each include a central processing unit (CPU) 122, non-transitory memory 124 that may include random access memory (RAM), read only memory (ROM), a hard drive (HD) and the like, input/output controller (I/O CNTL) 126 operatively coupled to input devices 126A such as, for example, a keyboard, mouse, light pen or other pointing device, and to output devices 126B such as, for example, a document, card or other medium reader or scanner, a printer, a monitor or other display device for facilitating input to and output from the system 100. In one embodiment, the computing devices 120 are comprised of, for example, a personal computer or work station, a notebook, tablet or netbook computer, iPAD, or the like computing device. IPAD is the registered trademark of Apple, Inc. (Cupertino, Calif. USA). In one embodiment, the output devices 126B include a device capable of both input and output such as, for example, a touch sensitive screen 126B1 that presents one or more graphical user interfaces (GUIs) 129 that exhibit information (e.g., product information) to prospective consumers and receive input (e.g., product identification/selection criteria) therefrom. In one embodiment, the computing devices 120 may be implemented as standalone devices executing software within memory 124 to exhibit information and/or features of one or more items or categories of merchandise. In one embodiment, the computing devices 120 include an electronic communication apparatus (COMMS) 128 for communicating, as indicated by reference numeral 127, with a computerized communication network 130 such as, for example, the Internet, an intranet, an extranet, or like distributed communication platform connecting computing devices over wired and/or wireless communication connections. The computing devices 120 configured with COMMS 128 may be networked to each other and/or with a server computing device, hereinafter server 140, located in a same facility or located remotely from the computing devices 120 to execute software within memory 124, or as provided by the server 120 to the computing devices 120, to exhibit information and/or features of the one or more items or categories of merchandise. In one embodiment, the computing devices 120 are coupled to a data store 150, directly, via the server 140 or via the network 130 (as shown in FIG. 2). The data store 150 stores digital content 152 defining and describing a digital inventory of merchandise 154 including data and/or information related to the merchandise, consumers 156, retailers 158 and/or purchase transactions 159.

In one embodiment, the server 140 executes systems and methods within a retailer's existing and/or legacy computer systems such as, for example, inventory control, compliance, warehousing, purchasing and reordering, and like systems. As such, the computing devices 120 and actions taken therewith (e.g., sales transactions) may trigger a recommendation, evaluation and/or action within the retailer's existing and/or legacy systems such as, for example, reordering actions as a retailer's stock or inventory of merchandise at one or more locations is reduced or depleted to minimum levels. Accordingly, it is within the scope of the present invention that improvements described by the digital shopping system 100 and the interactive retail shopping environment 110 discussed herein enhance the visible to actions and occurrences that lead to improvements in a retailer's overall inventory control and management. Additionally, the operative connection between the computing devices 120 and the server 140 permit a retailer to relatively simultaneously implement a universal or global sales or promotional initiative across a plurality of retailer locations. For example, and as described more fully below, the server 140 may instruct the one or more computing devices 120 to feature a select item or category of merchandise to encourage additional sales volume of that item or category of merchandise. Moreover, the retailer may simultaneously update one or more characteristics of a select item or category of merchandise such as, for example, implement a global change in price or issue a “hold” or “no sale” condition on a select item or category of merchandise, or the like.

As noted above, in one aspect of the invention the computing devices 120 may be disposed at various locations within a retail environment, including on the retail floor accessible by prospective consumers as well as behind a counter where retail sales staff and/or technical experts (e.g., pharmacist, electronics technician, jeweler or the like) may review a request or order for merchandise and retrieve (e.g., pick) a selected item of merchandise from the retailer's inventory of merchandise. Accordingly, one or more of the computing devices 120 may be operated to execute computed-implemented steps and/or algorithms (e.g., software) that process and present the data and/or information within the digital content 152 in a “user-friendly” way on the output devices 126B of the computing devices 120. It should be appreciated that the computer-implemented steps and/or algorithms generally require the manipulation of data and/or information in the form of electrical, magnetic and/or optical signals that may be inputted, stored, transferred, combined, compared and otherwise manipulated to provide a desired result. In one embodiment, a desired result includes visual representations of more or more of the data and information on the aforementioned GUIs 129 to facilitate a consumer's ability to locate and select merchandise, and/or a retailer's ability to pick and supply the selected merchandise and/or alternative or related merchandise to the consumers for purchase. For example, the computing devices 120 may direct the CPU 122, I/O CNTL 126, input device 126A and/or output device 126B to exhibit one or more of the GUIs 129 and to present data and information including, for example, the aforementioned digital content 152 including pricing, product information including, e.g., dosage, delivery form (tablet, capsule, and the like), product's commercial name, UPC/SKU code, size, quantity, product warnings, drug interaction cautionary notes etc. corresponding to one or more items within the digital inventory of merchandise 154.

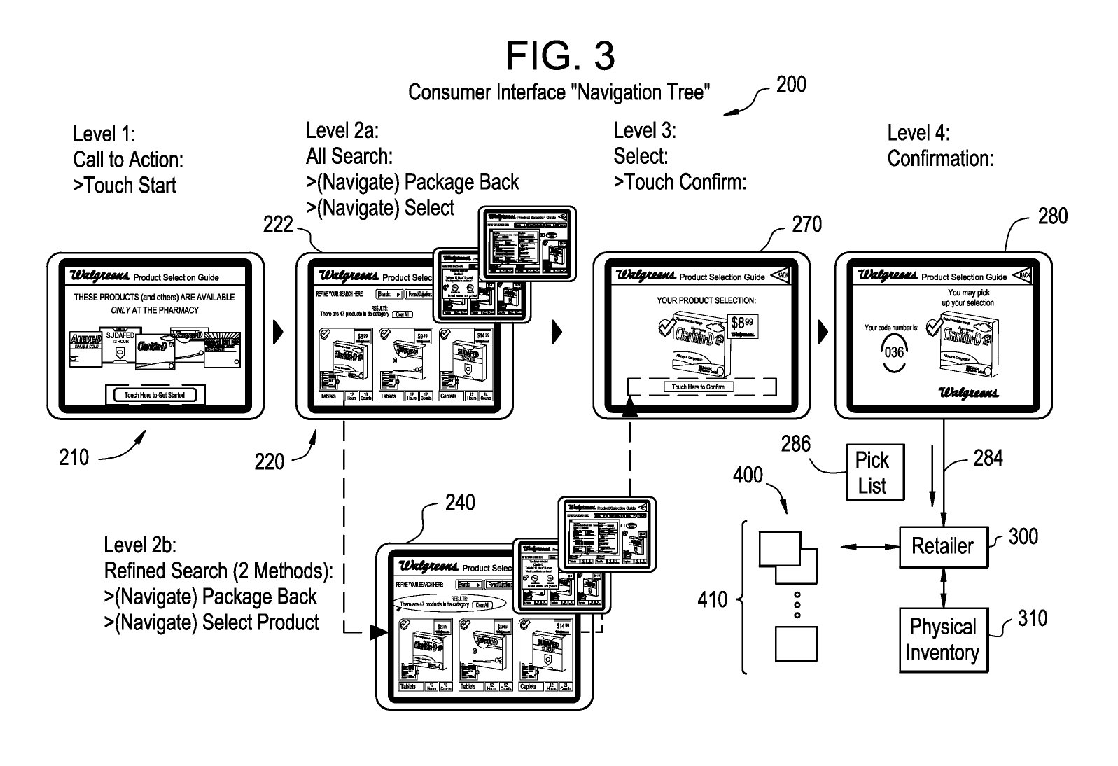

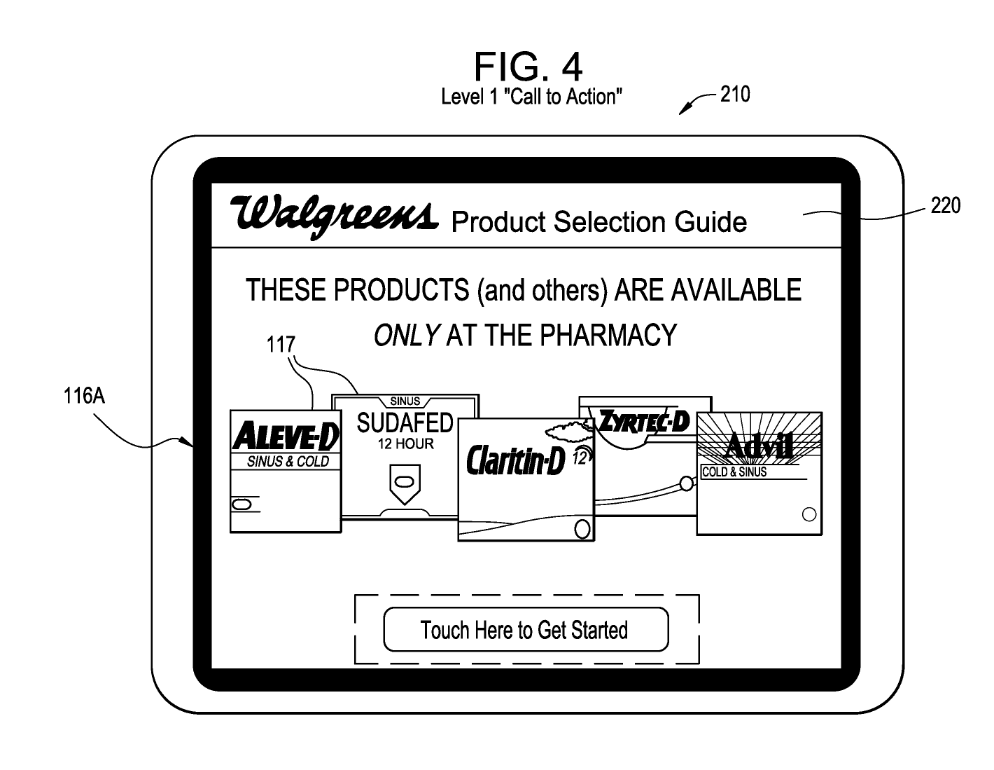

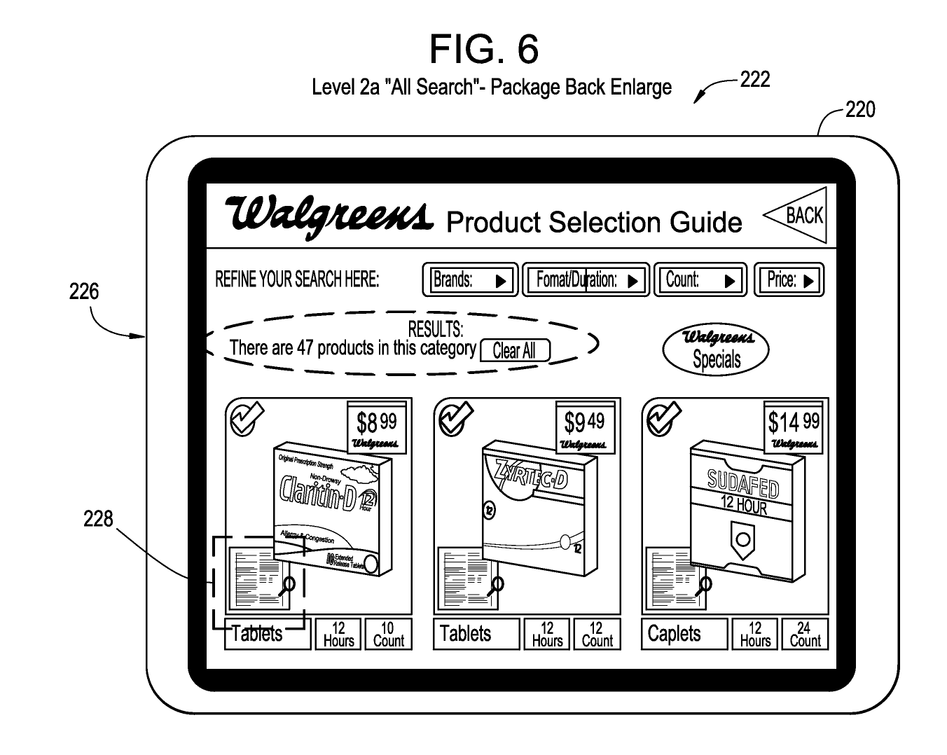

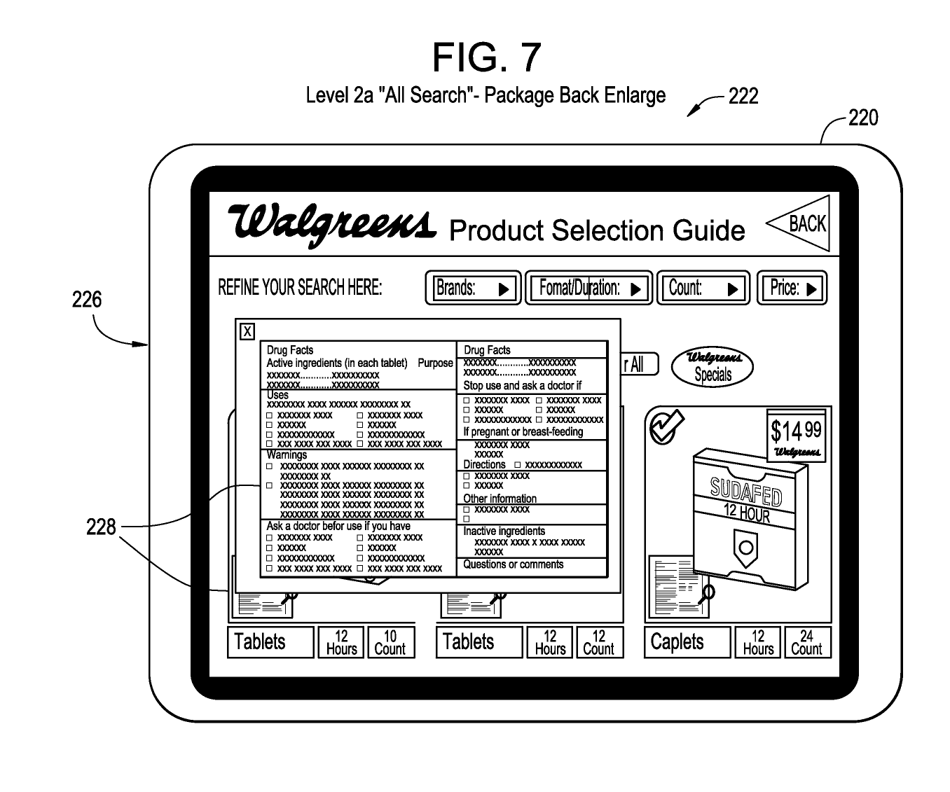

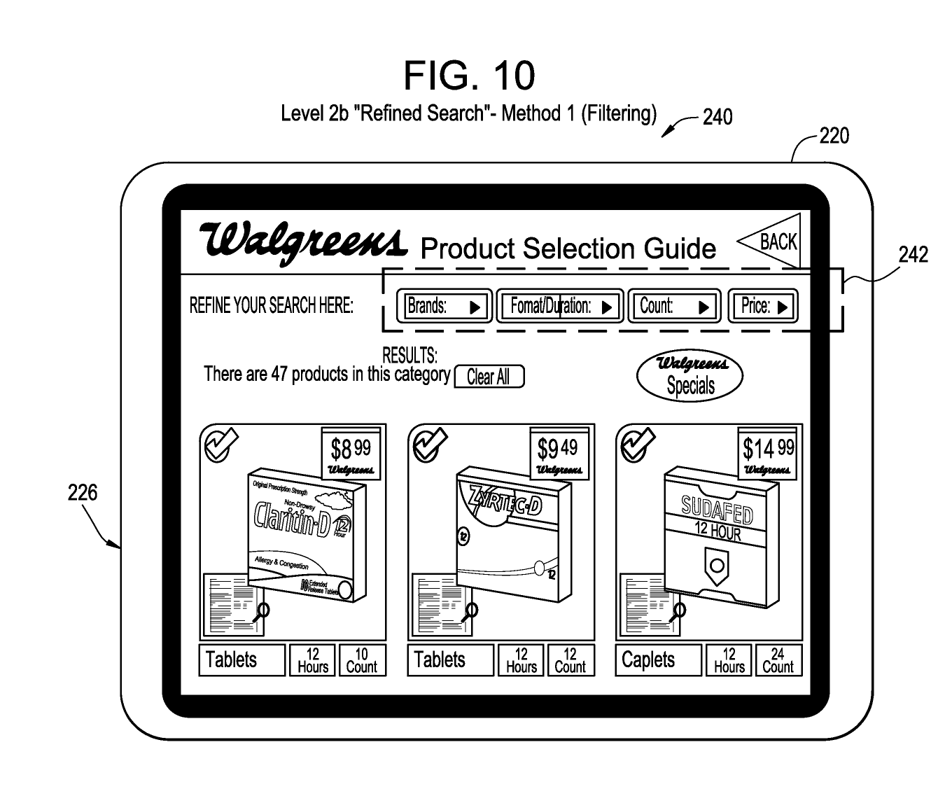

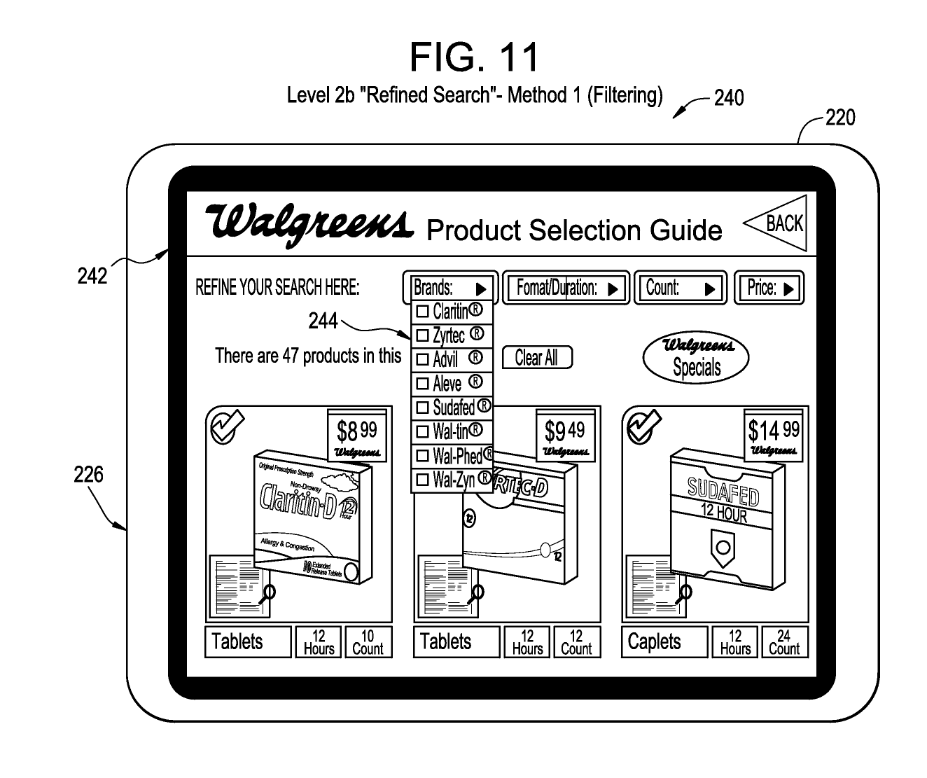

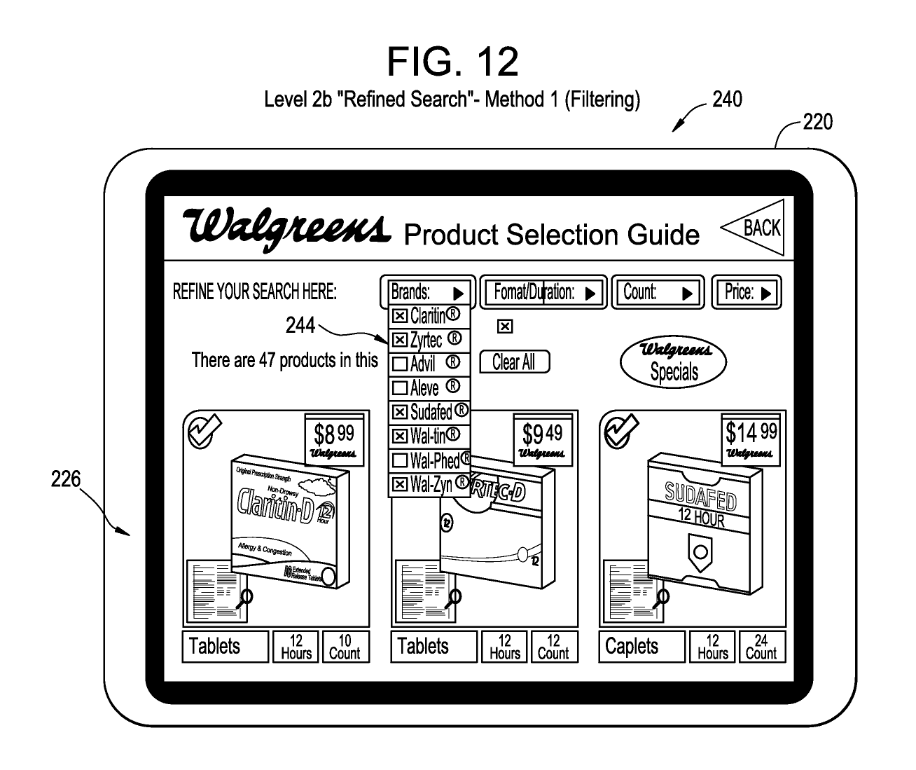

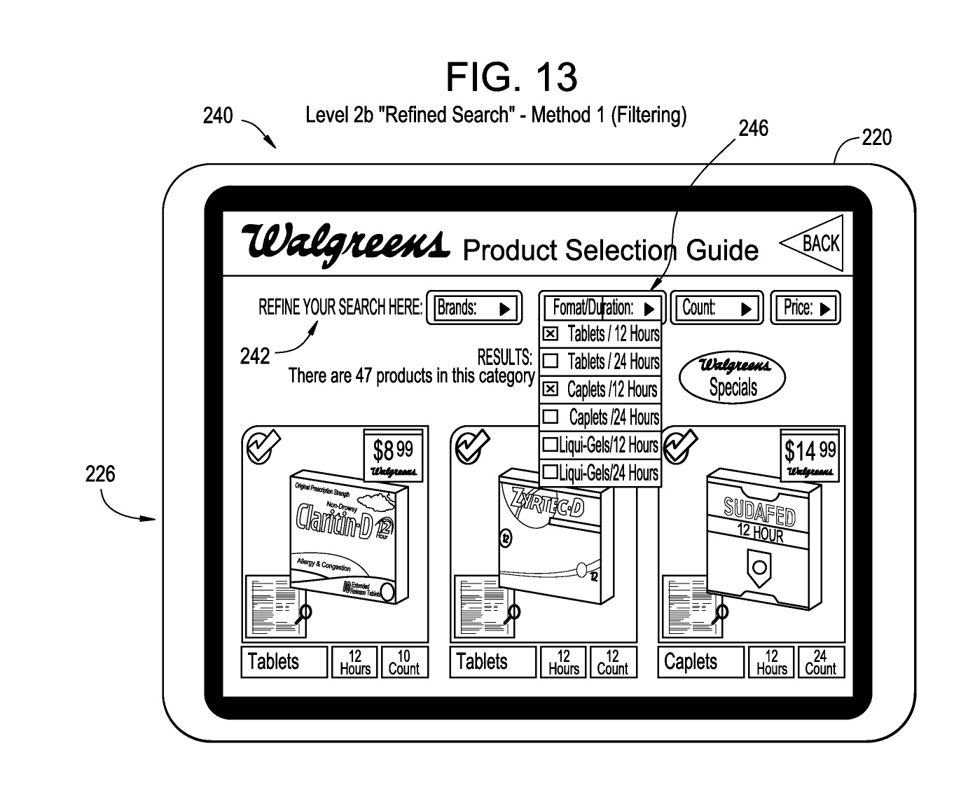

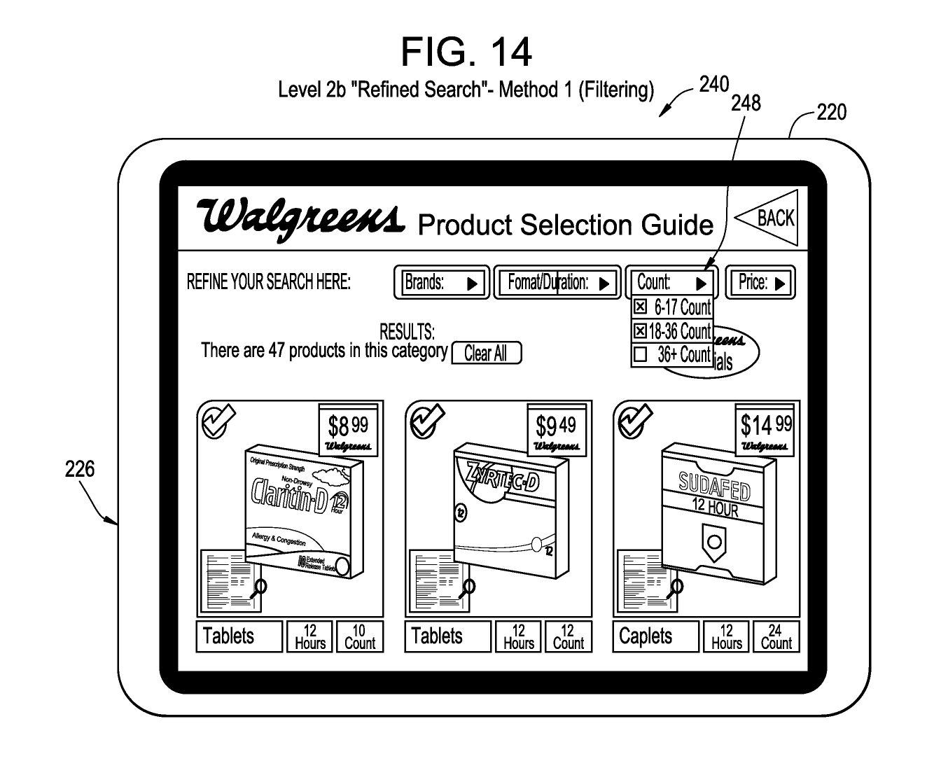

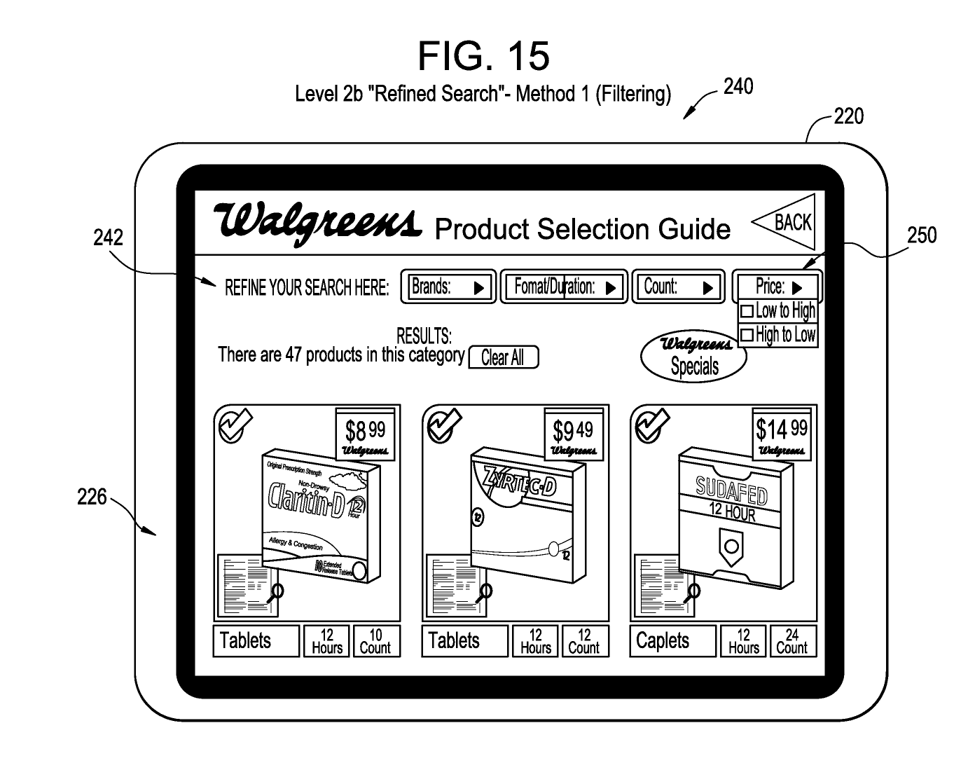

As shown in FIGS. 3 to 16, the digital shopping system 100 implements, on the one or more computing devices 120, a multi-step customer interface and navigation process 200 (e.g., four steps or levels shown) within the interactive retail shopping environment 110 through which consumers may operate one or more of the GUIs 129 to locate, review and select merchandise 116. In one embodiment, the customer interface 200 includes a Call to Action (e.g., activation) GUI 210 of the system 100 (labeled “Level 1” in FIGS. 3 and 4), and a Product Selection Guide GUI 220. The Product Selection Guide GUI 220 is customizable to provide searchable access to the digital inventory of merchandise 154 of the system 100 (labeled “Level 2a” 222 and “Level 2b” 240 in FIGS. 1 and 5 to 16) and includes electronic tools such as, for example, an enlargement tool 228 of a product package and labeling information (FIGS. 6 and 7), and a search refinement tool 242 for more fully specifying (e.g., narrowing) a search criteria provided to the Product Selection Guide GUI 220 (FIG. 10). The search refinement tool 242 permits filtering of merchandise within the digital inventory of merchandise 154 by, for example, selecting one or more from a dropdown list of brand names 244 (FIGS. 11 and 12), one or more from a dropdown list of delivery format and/or duration 246 (e.g., 12 hour tablets, 24 hour tablets, 12 hour caplets, 24 hour caplets, 12 hour liquid-gels, and the like, FIG. 13), one or more from a dropdown list of counts or quantity 248 (e.g., 8-17, 18-36, 36+, FIG. 14), one or more from a dropdown list of price display options 250 (e.g., low-to-high, high-to-low, and the like, FIG. 15) to assist in narrowing items within the digital inventory of merchandise 154 to those of interest to the particular consumer.

As shown in FIG. 4, the customer interface 200 includes the Call to Action (e.g., activation) GUI 210, wherein electronic representations 117 of select 116A items of merchandise 116 for which, for example, access may be limited or restricted are presented to the consumers. As can be appreciated, the electronic presentation 117 minimizes a retailer's risk that the select items 116A may be available to unauthorized consumers. As shown in FIG. 4, one category of select merchandise 116A includes medications that are typically only available to consumers over-the-counter at a pharmacy. Generally speaking, such restricted access to merchandise 116 inhibits prospective consumers from being able to freely examine and compare different brands and characteristics of the select merchandise 116A, for example, available dosages, delivery forms, and the like, to permit a more informed review and selection, without the assistance of, for example, personnel of the pharmacy. Accordingly, the electronic presentation 117 of the select merchandise 116A empowers consumers with an ability to assist themselves and conduct a more thorough examination of different merchandise purchase options while also allowing retailers to meet their legal and/or other requirement for restricting access to certain items 116A within their overall inventory of merchandise 116.

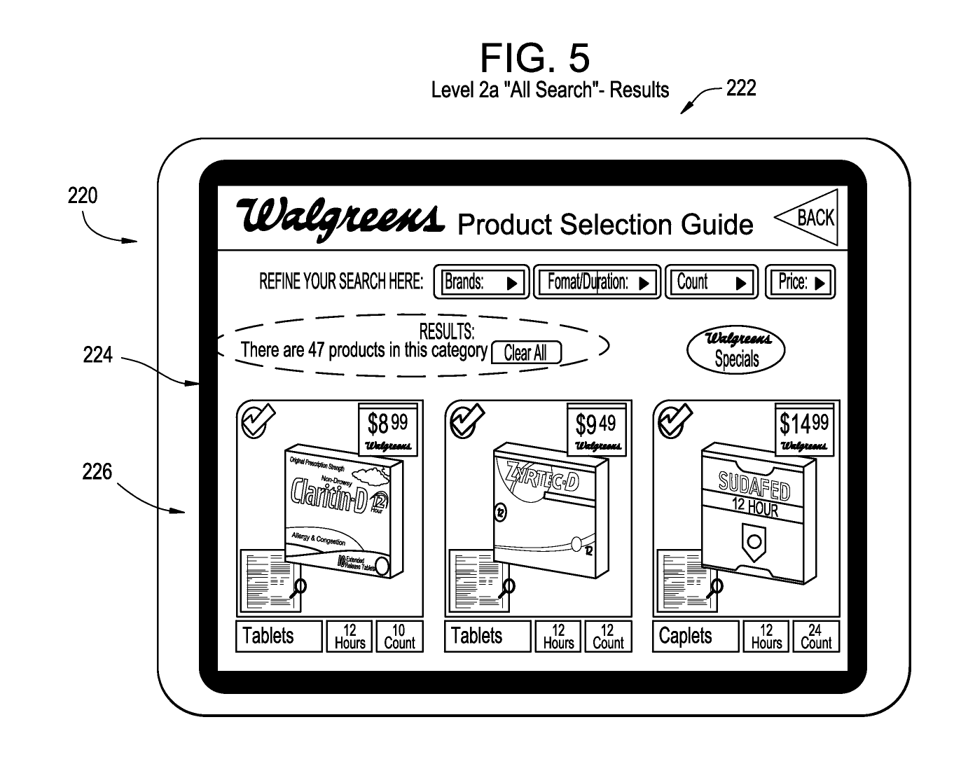

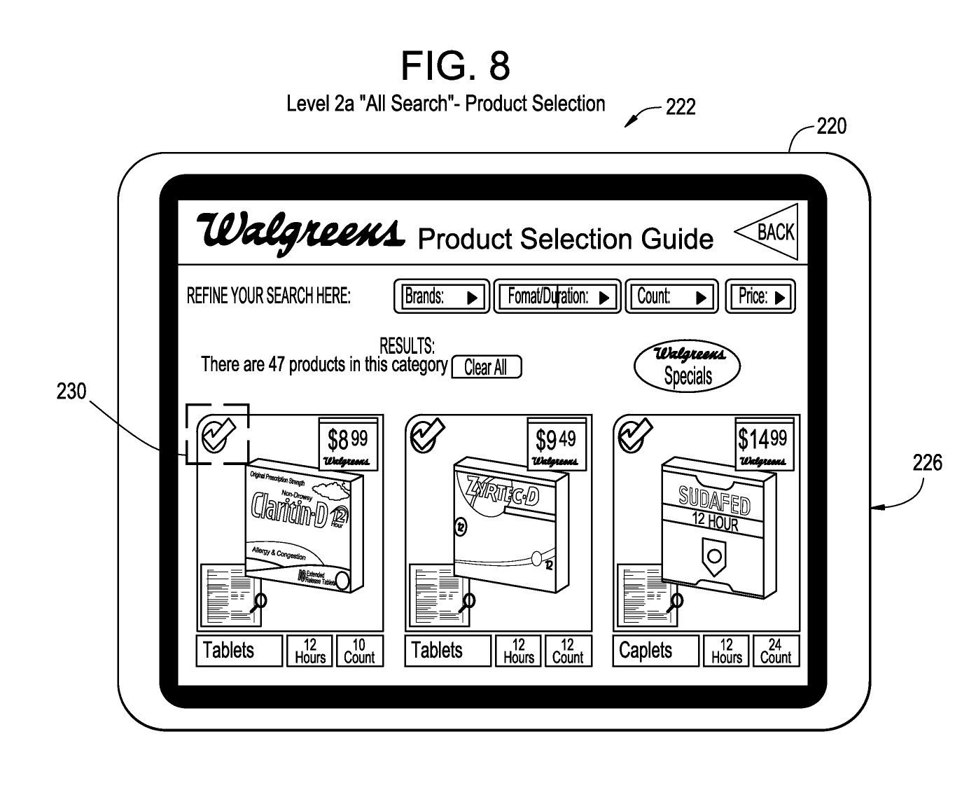

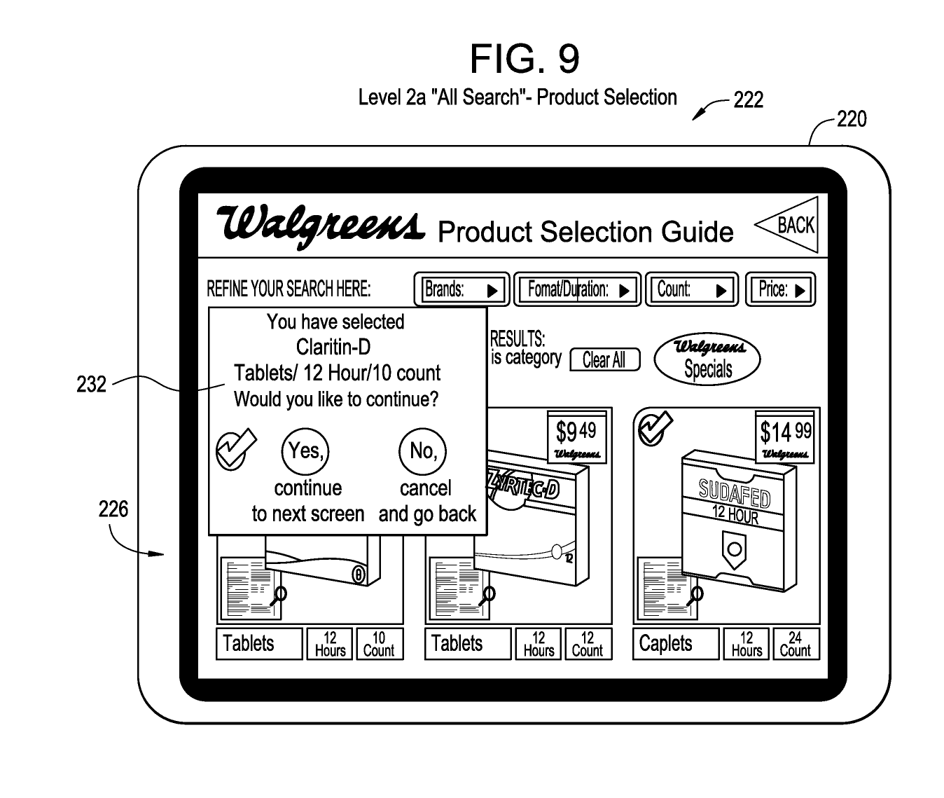

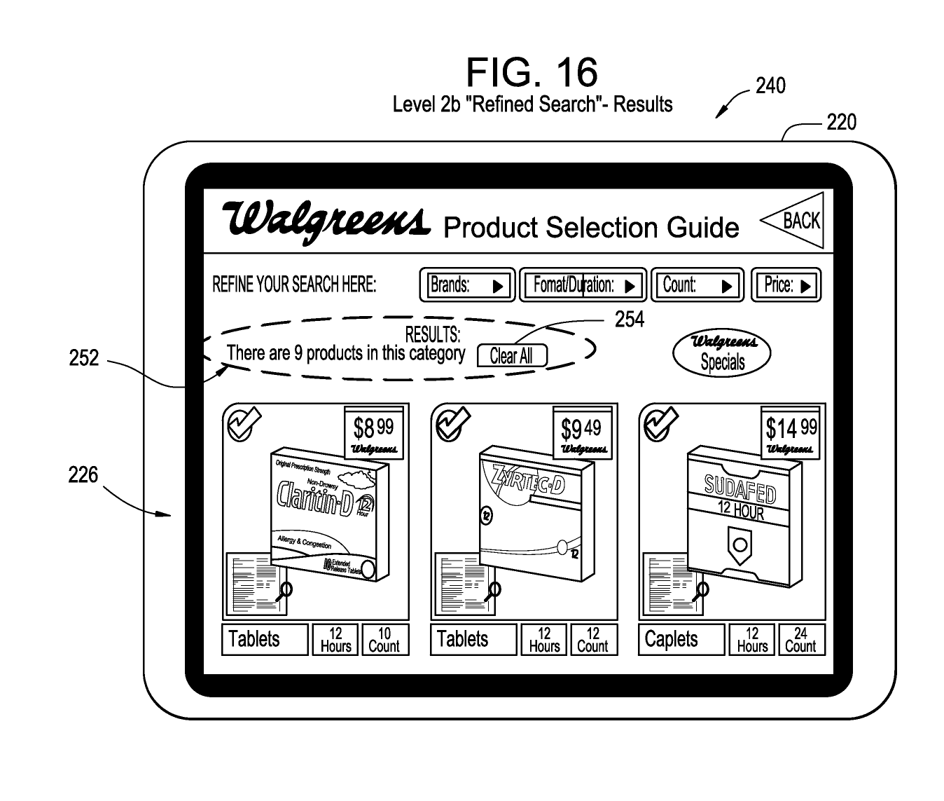

As shown in FIGS. 5 to 16, the Product Selection Guide GUI 220 is customizable by a prospective consumer to search the digital inventory of merchandise 154 to locate items of interest to the consumer. As shown in FIGS. 5 to 9, the Product Selection Guide GUI 220 may be operated to identify all items within a particular category of merchandise (a “Level 2a—All Search Results” view 222). For example, as shown in FIG. 5, one category of merchandise 116 includes forty-seven (47) products, shown generally at 224. In one embodiment, the identified products are exhibited in a side-by-side presentation, shown generally at 226, where one or more characteristics of the merchandise may be compared by the prospective consumer. In one embodiment, the Product Selection Guide GUI 220 includes one or more electronic tools operable by the prospective consumers to review one or more characteristics of the merchandise in more detail. For example, and as illustrated in FIGS. 6 and 7, the electronic tools include the enlargement feature 228 wherein product package and labeling information is exhibited in a more user-friendly manner by, for example, enlarging the text to make it more readable on the GUI 220. As illustrated in FIGS. 8 and 9, one or more items of merchandise within the side-by-side comparison 226 may be selected, as shown generally at 230. In one embodiment, the selection 230 is confirmed at 232 (FIG. 9) where one or more characteristics of the selected item are exhibited to the consumer and either “accepted” by the consumer initiating, for example, a movement forward to a next screen, or “not accepted” initiating a return to the side-by-side comparison 226. As noted above and as illustrated in FIGS. 10 to 16, the search refinement tool 242 allows a prospective consumer to more fully specify (e.g., narrow) a search criteria provided to the Product Selection Guide GUI 220 to, in effect, implement a consumer specific selection (inclusion) and/or de-selection (exclusion) criteria. For example, and as illustrated by comparing FIGS. 5 and 16, by specifying one or more of the brand names 244, the delivery format and/or duration 246, the counts or quantity 248, and/or the price display options 250, the products within the side-by-side comparison of products 216 are filtered from a presentation of forty-seven (47) products (at 224 of FIG. 5) to a presentation of nine (9) products, shown generally at 252 of FIG. 16. It should be appreciated that the filtering is customizable to accommodate the needs of any of the prospective consumers and should a particular setting be already defined within the search refinement tool 242 by, for example, operation by a previous consumer, a new consumer may reset the refinement tool 242 to “clear” the refinement values or to set default refinement values by selection of a Clear All control 254 (FIG. 16).

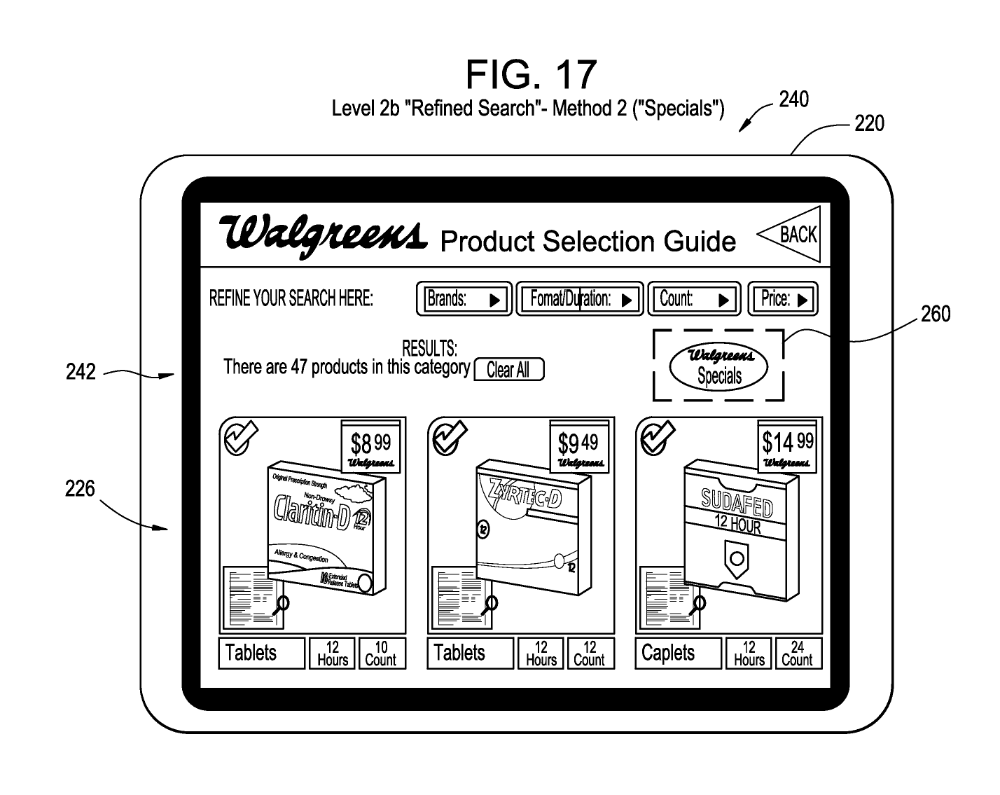

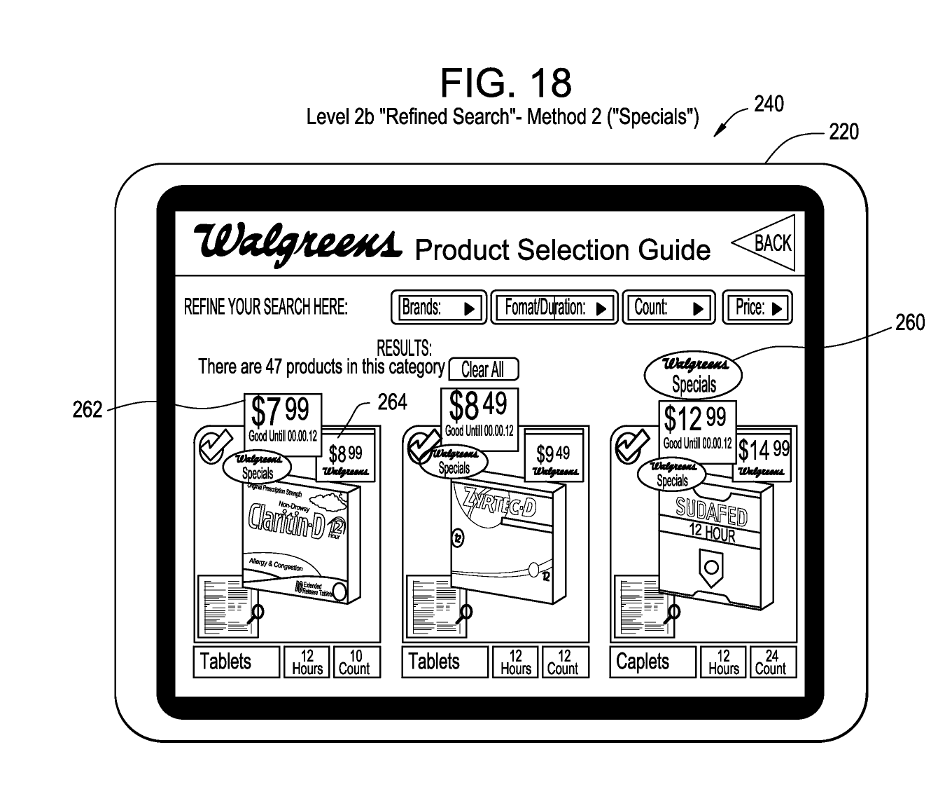

In one embodiment, illustrated in FIGS. 17 and 18, the retailer may present via the Product Selection Guide GUI 220, incentives and/or “specials” 260 to encourage movement/sale of one or more items of merchandise 116 within the inventory of merchandise 154. The incentives and/or specials 260 may include, for example, a reduced price 262 as compared to an otherwise posted price 264, an additional quantity of a featured item of merchandise 116 such as, for example, a two (2) for one (1) special, and the like.

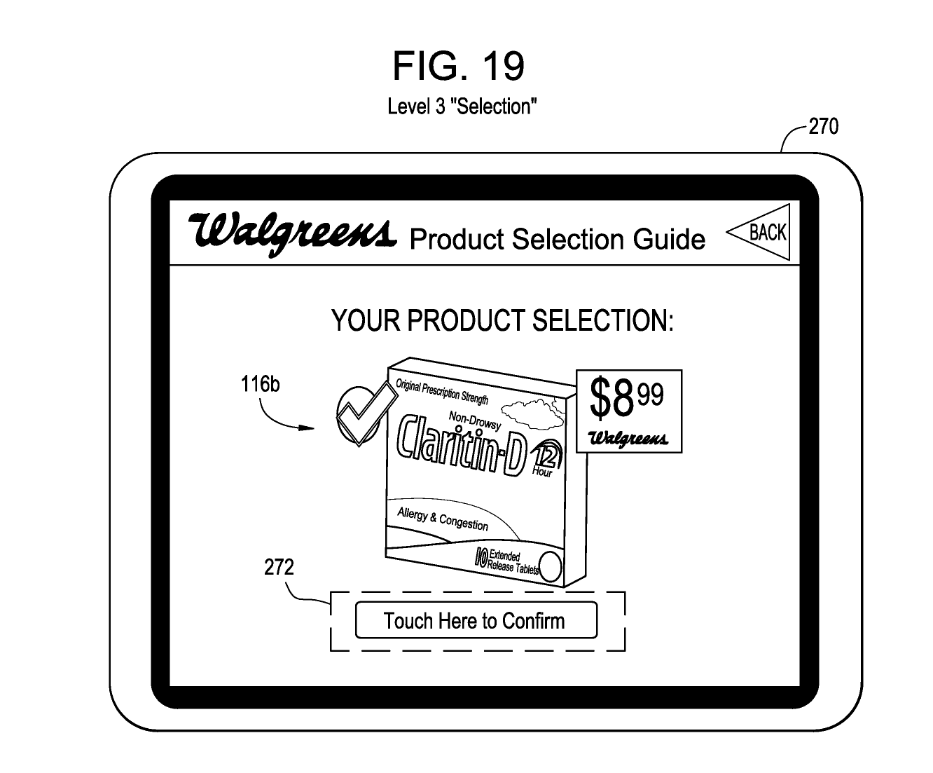

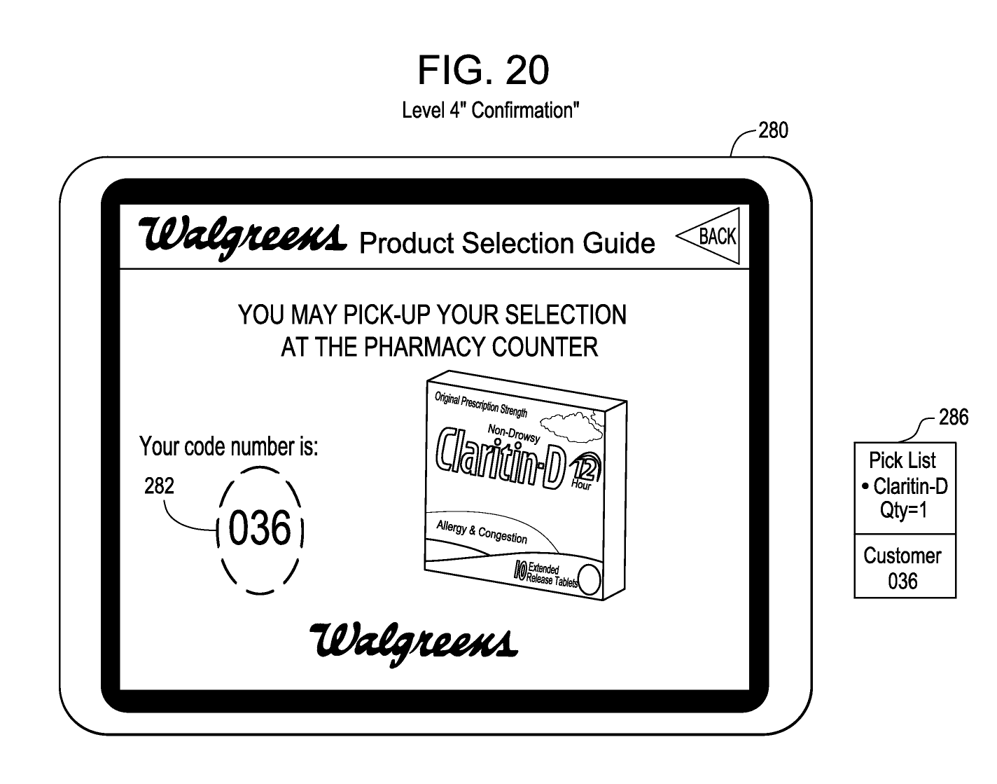

Referring again to FIG. 3, the prospective consumer operates the Product Selection Guide GUI 220 to locate and select one or more items within the digital inventory of merchandise 154. In one embodiment, once selected, the Product Selection Guide GUI 220 presents the one or more selected items of merchandise 116B to the consumer so that the consumer may confirm his/her selection, shown generally at 270 (FIGS. 3 and 19). At this Product Selection step 270 (labeled “Level 3” in FIGS. 3 and 19) the one or more selected items of merchandise 116B are exhibited to the consumer for confirmation by, for example, activating a Touch Here to Confirm command 272. In one embodiment, the Product Selection GUI 270 may highlight one or more characteristics of the one or more selected items 116B, for example, price. In one embodiment, the Product Selection GUI 270 may also present to the consumer one or more related or alternative items merchandise such that the consumer may consider adding items to their purchase. Activation of the Confirm command 272 triggers an Order Confirmation step 280 (FIG. 20). In one embodiment, at the Order Confirmation step 280 the system 100 generates and presents a unique customer identification or code 282 and a notification 284 to a retailer 300 such as for example, a pick list 286. The notification 284 and the pick list 286 advise the retailer 300 to retrieve the one or more selected items 116B of merchandise 116 from a physical inventory 310 (e.g., off the retail floor or from a storage location of the retailer 300) such that the selected items 116B may be provided to the customer at a point of purchase such as, for example, a sales counter, cash register or the like.

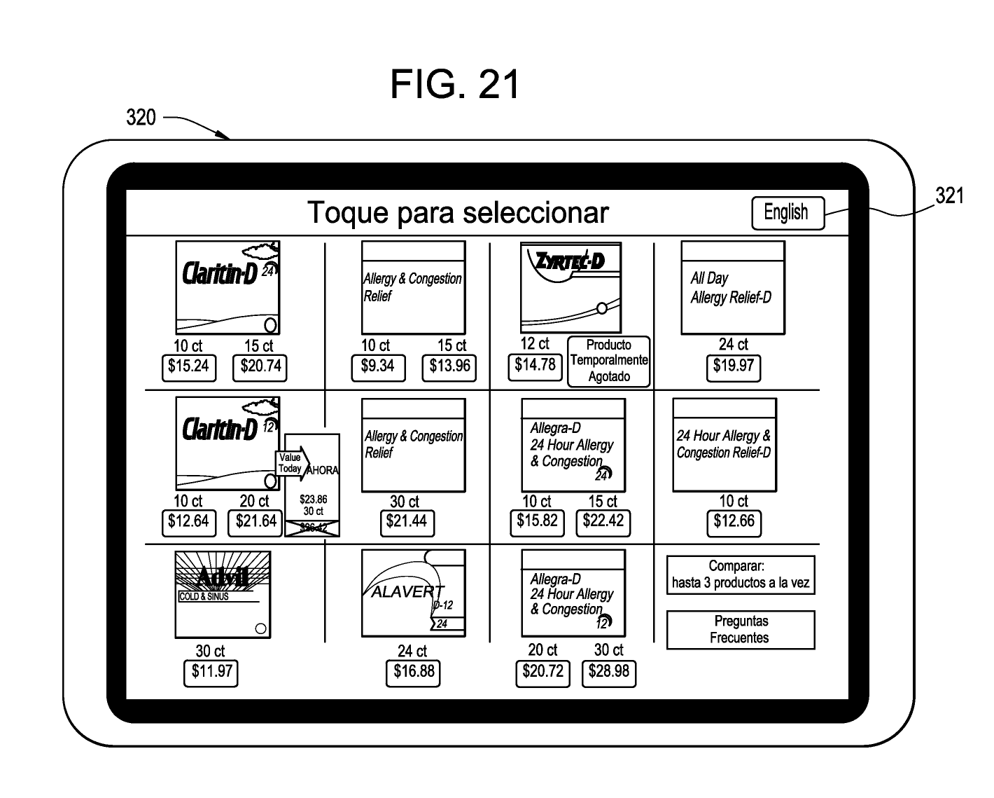

In another aspect of the invention, illustrated in FIG. 21, the Product Selection Guide GUI 220 is implemented as a multi-lingual Product Selection Guide 320 to provide a more informed consumer search and selection of products within the digital inventory of merchandise 154. In one embodiment, a control 321 allows a consumer to select between one or more languages. In response to the selection, text of the Product Selection Guide GUI 220 is converted.

Referring again to FIG. 3, in one embodiment, the retailer 300 may access a retailer interface, shown generally at 400, which includes one or more GUIs 410 that provide access to inventory control information from which the retailer 300 assembles “orders” received via the notifications 284 and/or pick lists 286 generated from the Consumer Interface 200. In one embodiment, the retailer 300, in response to the one or more selected items 116B of merchandise 116 received in the notifications 284 and/or pick lists 286, may present to the consumer at the point of purchase and/or receipt of the selected items 116B from the physical inventory 310, a choice of one or more alternative merchandise that meet the consumer's selection and/or are related or complimentary to the consumer's selection. In one embodiment, the retailer interface 400 may provide a presentation of comparison data and/or information that the retailer can present to the consumer at the point of purchase to encourage selection of the alternative merchandise, further sales of related merchandise, a purchase option that is more competitive (e.g., lower cost, greater quantity or the like) or is more profitable (e.g., greater profit margin) for the retailer 300, and the like.

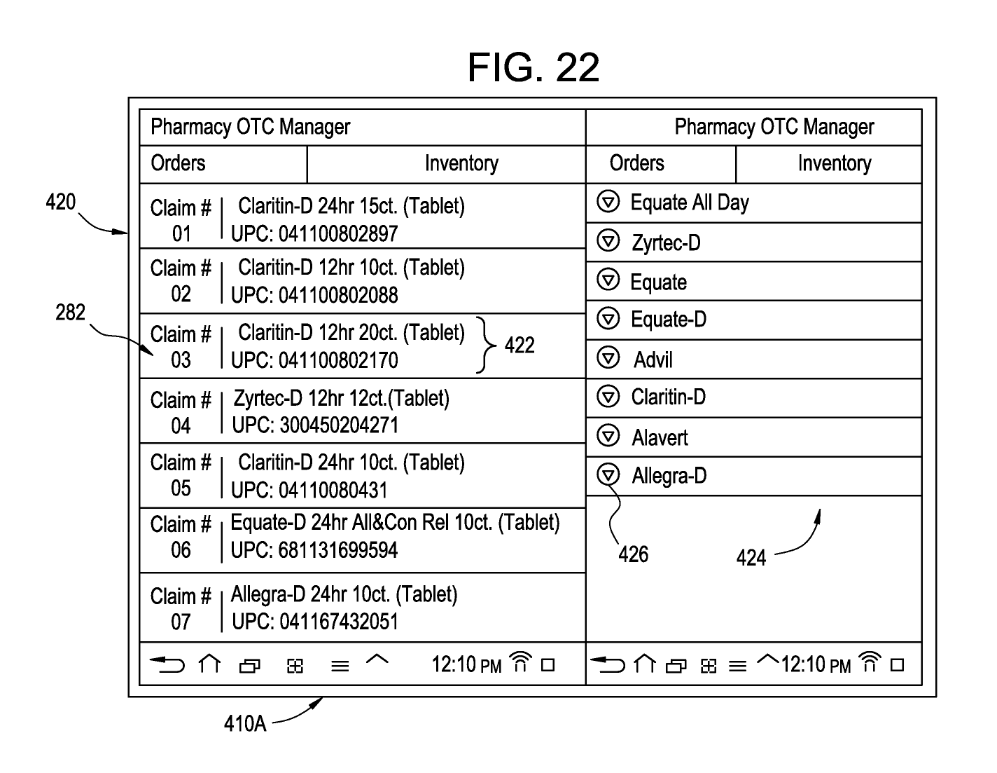

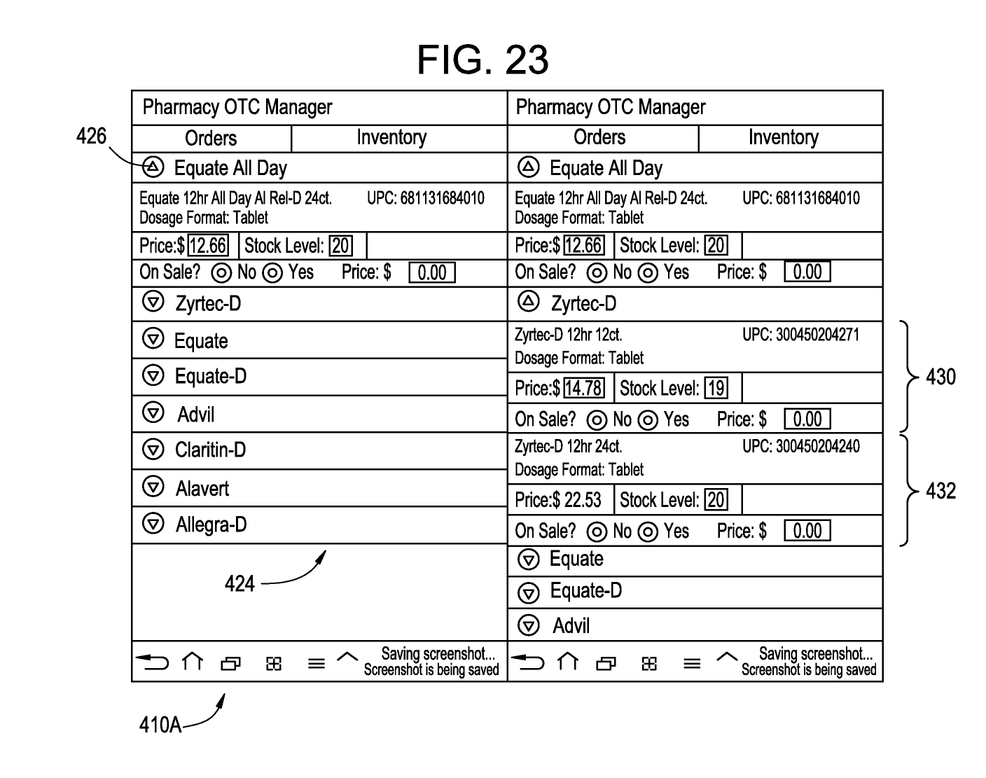

FIGS. 22 and 23 illustrate one embodiment of the retailer interface 400 which includes GUIs 410 for providing, for example, a pharmacy over-the-counter (“OTC”) management solution accessible by personnel of the retailer 300 such as, for example, a pharmacist, technician, or the like. As shown in FIG. 22, a Pharmacy OTC Manager GUI 410A presents orders 420 placed by one or more consumers using the Product Selection Guide GUI 220 described hereinabove. In one embodiment, the orders 420 are exhibited in an ascending sequence by customer identification or code 282, labeled “Claim #” in FIG. 22, and include a description 422 of the one or more selected items 116B of merchandise 116 chosen by the consumers. In one embodiment, the Pharmacy OTC Manager GUI 410A may also exhibit the order information in an inventory view, shown generally at 424, such that for example, available quantities of merchandise can be readily determined by the personnel. As shown in FIG. 23, selecting a control 426 on the inventory view 424 presents detailed information with respect to a subject item of merchandise such as, for example, product description, Universal Product Code (“UPC”), price, dosage format, inventory or “stock” level, whether the product is on sale, and the like, on the Pharmacy OTC Manager GUI 410A. As shown generally at 430 and 432, the Pharmacy OTC Manager GUI 410A highlights choices of one or more alternative merchandise that meet the consumer's selection and/or are related or complimentary to the consumer's selection.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments and the configurations and components described herein will fall within the spirit and scope of this invention and of the appended claims.

What is claimed is:

1. An interactive retail shopping system comprises:
one or more computing devices each including a processor, memory operatively coupled to the processor and a display device operatively coupled to the processor for exhibiting data and information thereon; and
a data store coupled to the one or more computing devices, the data store including data and information defining an inventory of merchandise;
wherein the processor executes computer implemented instructions whereby the processor is configured to allow consumers to locate, review and select merchandise from within the inventory of merchandise, and to allow a retailer to pick and to present the selected merchandise, alternative merchandise and/or related merchandise to the consumers for purchase within a retail shopping environment.

2. The interactive shopping system of claim 1, wherein the data and information exhibited on the display device includes merchandising, promotional and purchasing data and/or information including pricing, product information including dosage, delivery form such as tablet and capsule forms, product's commercial name, UPC/SKU code, size, quantity, product warnings, and drug interaction cautionary notes.

3. The interactive shopping system of claim 1, wherein at least one of the one or more computing devices further includes an electronic communication apparatus such that the at least one computing device communicates over a network with a server computing device, and wherein the server computing device is configured to execute the retailer's existing inventory control system such that actions taken with the at least one computing device trigger a recommendation, evaluation and/or action within the retailer's existing inventory control system.

4. The interactive shopping system of claim 3, wherein the action taken within the retailer's existing inventory control system in response to the trigger by the at least one computing device includes reordering actions as the retailer's inventory of merchandise is reduced to a predetermined level.

5. The interactive shopping system of claim 3, wherein the action taken within the retailer's existing inventory control system in response to the trigger by the at least one computing device includes a relatively simultaneously implementation of sales initiative within the retailer shopping environment.

6. The interactive shopping system of claim 3, wherein the action taken within the retailer's existing inventory control system in response to the trigger by the at least one computing device includes a relatively simultaneously implementation of a change to one or more characteristics of a select item or category of merchandise within the inventory of merchandise.

7. The interactive shopping system of claim 1, wherein the processor is configured to execute a customer interface including electronic tools operable to assist in the location, review and selection of merchandise from within the inventory of merchandise.

8. The interactive shopping system of claim 7, wherein the electronic tools include an enlargement tool operable to provide an enlarged presentation of one or more characteristics of the merchandise.

9. The interactive shopping system of claim 7, wherein the electronic tools include a product selection guide operable to provide customizable, searchable access to the merchandise by a search refinement tool that permits entry of search criteria, the search criteria defining a method for selectively filtering the merchandise within the inventory of merchandise.

10. The interactive shopping system of claim 9, wherein the search criteria includes a definition of at least one of a brand name of the merchandise, a delivery format and/or duration of the merchandise, a count or quantity of the merchandise, and a price display option for exhibiting the selected merchandise.

11. The interactive shopping system of claim 7, wherein the customer interface exhibits the merchandise within the inventory of merchandise on the display device in a side-by-side presentation wherein one or more characteristics of the merchandise are readily apparent.

12. The interactive shopping system of claim 1, wherein the processor is configured to execute a retailer interface including inventory control information related to selected items of merchandise from within the inventory of merchandise.

13. The interactive shopping system of claim 12, wherein the retailer interface exhibits an order view and an inventory view of the selected items of merchandise.

14. The interactive shopping system of claim 13, wherein the inventory view of the retailer interface highlights at least one of one or more alternative merchandise that meet the consumer's selection and one or more of related and complimentary merchandise to the consumer's selection.
